(19) United States
(12) Patent Application Publication
(10) Pub. No.: US 2006/0291334 A1
(43) Pub. Date: Dec. 28, 2006

(54) Radio controlled wristwatch

(76) Inventor: Wolfgang Heck, Kassel (DE)

Correspondence Address: WELSH & KATZ, LTD, 120 S RIVERSIDE PLAZA, 22ND FLOOR, CHICAGO, IL, 60606, US

(21) Appl. No.: 11/166,635

(22) Filed: Jun. 24, 2005

(51) Int. Cl. G04C 23/02; G04B 37/00

(52) U.S. Cl. 368/47; 368/88

(57) ABSTRACT

The subject matter of the invention is a radio wristwatch with a receiving unit, an aerial (16) and a clockwork that are all housed in a casing (30), said casing (30) including a substantially annular casing frame (32), characterized by a separate container module (10) that accommodates the receiving unit, the aerial (16) and the clockwork, a glass ring (36) retaining a watch-glass (34) being removably mounted on the upper side of the casing frame (32), a bottom (38) being firmly inserted on the lower side of the casing frame (32) and the container module (10) being form-fittingly inserted from the top into the casing frame (32) and fixed in the casing by said glass ring (36).

### BACKGROUND OF THE INVENTION

1. Field of the Invention

The present invention relates to a radio wristwatch in accordance with the preamble of claim 1.

2. Description of the Prior Art

Like in the radio wristwatch known from DE 299 23 446 U1, the radio controlled movements of radio wristwatches are mounted from the bottom in a substantially small casing frame, said casing frame being closed from the top with the watch-glass. Next, a bottom ring for receiving a bottom is pressed into the casing frame so as to close the casing. In order for the bottom ring to be reliably retained on the casing frame, there are provided detent edges past which the bottom ring is pressed to be retained on the casing frame. In order to allow for the thereby occurring forces to be absorbed, both the casing frame and the bottom ring must have the appropriate thickness dimensions.

With radio wristwatches, the problem always is that metallic objects shield at least partially the aerial housed within the casing so that the reception sensitivity of these aerials is reduced as a result thereof.

The current state of the art teaches that radio wristwatches should have a bottom made from a non-metallic material in order not to needlessly reduce the reception sensitivity of the aerial. Even with a non-metallic bottom, the prior art radio wristwatches have a reception sensitivity in excess of 200 microvolt per meter, such a sensitivity being only achievable with relatively large aerials.

### BRIEF SUMMARY OF THE INVENTION

In view thereof, it is the object of the present invention to provide a radio wristwatch of the type mentioned herein above that permits to improve the reception sensitivity in metal casings.

Technically, this object is solved in accordance with the invention by a radio wristwatch having the features of claim 1. Advantageous developed implementations of this radio wristwatch are recited in the subordinate claims.

A radio wristwatch configured in accordance with this technical teaching has the advantage that the bottom can be firmly attached to the casing frame by mounting the container module from the top into the casing frame. Also, this permits to dispense with the need for the prior art bottom ring. By mounting the container module from the top, one also achieves that the forces generated when the bottom ring was inserted into the casing frame no longer occur so that the casing frame can be configured to be significantly thinner at this place as a result thereof. Concurrently, the glass ring may also be configured to be relatively small since the quite robust watch-glass absorbs a fraction of the forces generated there. The forces exerted on the casing frame being reduced in this way, a significantly thinner casing frame may be utilized. As a result of this reduction together with the obviation of the bottom ring, the whole casing of the radio wristwatch of the invention comprises far less metal which in turn results in a significantly reduced shielding of the aerial. First tests showed that the thin implementation of the casing frame and the obviation of the bottom ring permit to increase the reception sensitivity of the aerial by 20 to 25%. This in turn results in a very reliable reception of the radio signal. Alternatively, the aerial could also be configured to be smaller, which would result in significantly more filigreed radio wristwatches.

Another advantage is that the radio controlled movement with its receiving unit, its aerial and its clockwork may be industrially prefabricated in an encapsulated container module and, most notably, be completely mounted to be then inserted as a unit from the top into the casing of the radio wristwatch, or rather into the substantially annular casing frame. It is understood that the dimensions of the container module and the dimensions of the casing frame are mated so that the container module is form-fittingly retained in the casing frame. The casing is closed with the glass ring and the watch-glass retained therein with the container module being concurrently fixed thereby.

Yet another advantage of the invention is that such a prepared, separate container module also considerably facilitates insertion of the radio controlled movement into the casing, thereby further reducing the cost of a radio wristwatch.

Another advantage is that such an encapsulated container module protects the radio controlled movement against damage and dirt and that increased product quality is achieved in this case.

In a preferred embodiment, the radio controlled movement with its receiving unit, its aerial and its clockwork is mounted on a movement carrier to which a container cover is also fastened. The advantage thereof is that mounting the discrete components of the radio controlled movement on the movement carrier and subsequently closing the container module with the container cover will enable low cost manufacturing of the container module.

In a preferred developed implementation, the clockwork includes a printed circuit board, a wheel train and an energy storage unit, with the energy storage unit being preferably implemented as a battery and a recess for replacing the battery being provided in the container cover, in the region of the battery. As a result, the battery may be replaced at need without having to open the container module itself. This additionally protects the radio controlled movement which results in a long usable life.

In another preferred embodiment, two detent lugs are preferably formed on the container module, more specifically on the movement carrier, characterized. With such a detent system, fastening of the container cover is simple and fast to perform.

In another preferred embodiment, a position recess or a position lug are formed on the movement carrier and/or on the container cover. A mating projection or a mating depression is formed on the casing ring to correspond to said position recess or to said position lug so that the container module can be retained in the casing by this position recess or by this position lug in an accurately defined position with respect to the casing frame. As a result, it is possible to place the aerial at an accurately defined position within the housing to ensure best possible reception of the radio signal. Another advantage is that the container module is thereby prevented from rotating out of place with respect to the casing frame.

It has further been found advantageous to attach to the container module a clock face or, in the case of a digital display, an LCD-display so that these may also be readily inserted into the radio wristwatch.

In another preferred embodiment, an inwardly directed shoulder against which the container module comes to rest is preferably formed in the lower region of the casing frame. A limit stop for receiving the container module is thus provided so that the container module is reliably and form-fittingly secured from coming out of place in the casing frame.

It has been found advantageous to insert the container module together with a clock face and the hands from the top into the casing frame since this permits to dispense with the need for a removable bottom, which introduces the advantages described herein above.

Further advantages of the radio wristwatch of the invention will become apparent in the appended drawings and in the following description of embodiments thereof. Likewise, the invention lies in each and every novel feature or combination of features mentioned above or described herein after. The embodiments discussed herein are merely exemplary in nature and are not intended to limit the scope of the invention in any manner.

### BRIEF DESCRIPTION OF THE DRAWING

FIG. 1 is an exploded view of a container module for a radio wristwatch of the invention;

FIG. 2 is an exploded view of a radio wristwatch of the invention with a container module in accordance with FIG. 1;

FIG. 3 is a sectional side view of the radio wristwatch according to FIG. 2 with a container module according to FIG. 2.

### DETAILED DESCRIPTION OF THE INVENTION

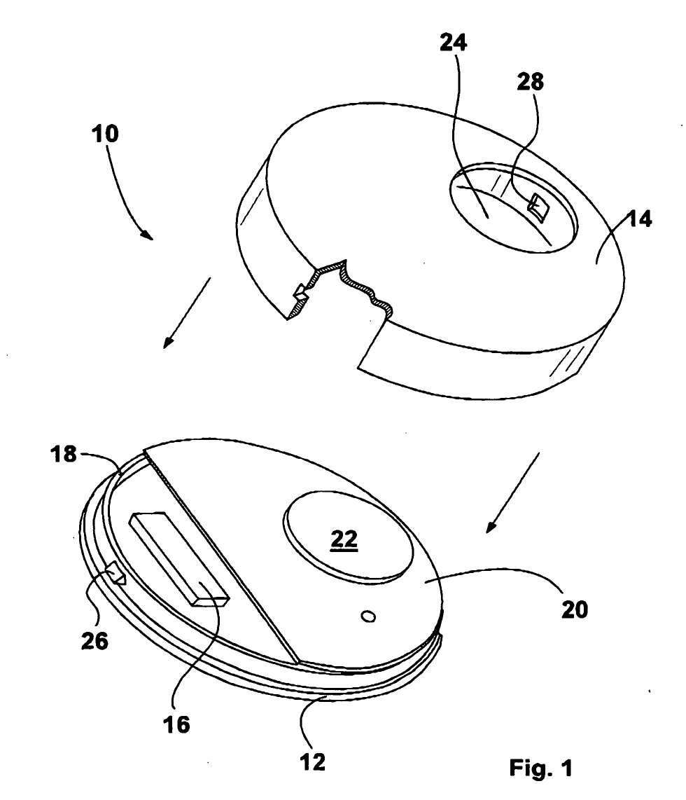

FIG. 1 illustrates a container module 10 including a movement carrier 12 and a container cover 14. On its lateral side edge portion, said movement carrier 12 accommodates an aerial 16 and in its center a wheel train that has not been illustrated in closer detail herein. The edge of the movement carrier 12 comprises a substantially circumferential shoulder 18 onto which a printed circuit board 20 is resting. Parts of the clockwork and the receiving unit, which have both not been illustrated in further detail herein, are mounted on the printed circuit board 20. A flat battery 22 employed as the energy storage unit is retained on the rear side of the printed circuit board 20.

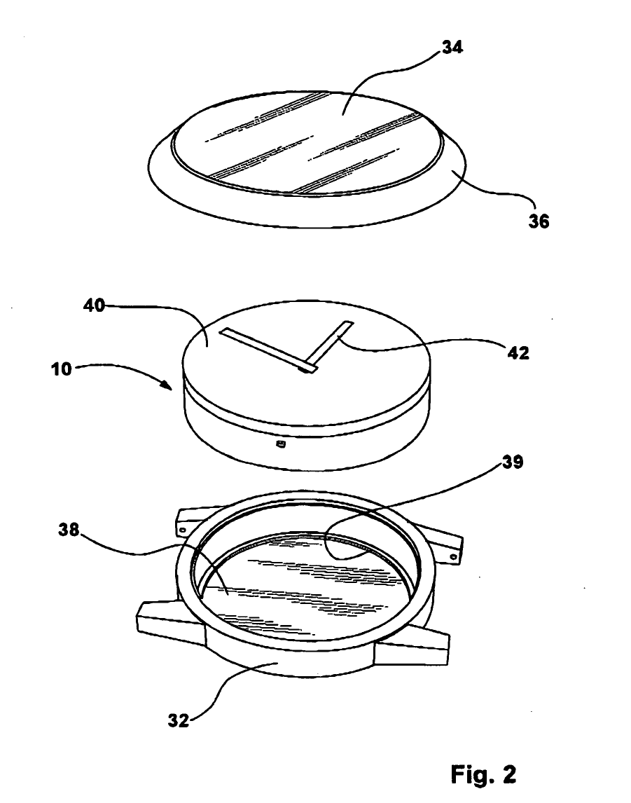

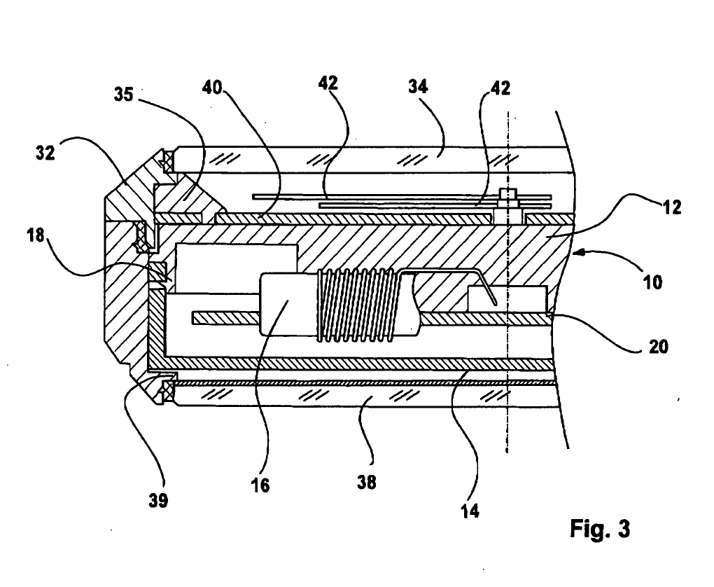

The outer edge of the movement carrier 12 with its shoulder 18 is configured like a clockwork retaining ring and is dimensioned such that the container module 10 is form-fittingly retained in a casing illustrated in the FIGS. 2 and 3.

In the container cover 14 there is provided a recess 24 through which the battery 22 passes. As a result, the battery 22 may be replaced without having to open the container module 10.

On the outer edge of the movement carrier 12, two detent lugs 26 that are positioned opposite each other on the circumference of the shoulder 18 are formed integral with the shoulder 18. Two mating detent slots 28 are formed on the container cover 14 to correspond with said detent lug 26. If one places the container cover 14 onto the movement carrier 12, said container cover 14 precisely fits on the shoulder 18 and is thus positioned on the movement carrier 12. The container cover 14 is thereby at first slightly urged apart by the detent lugs 26. As soon however as the detent lugs 26 reach the detent slots 28, the container cover 14 springs back into its initial position, subject to the restoring forces inherent to the material, so that the detent lugs 26 completely engage the detent slots 28 and reliably retain the container cover 14 on the movement carrier 12.

In another embodiment that has not been illustrated herein, position lugs or position recesses corresponding to mating projections or bight portions within the casing frame are provided on the movement carrier or on the container cover in order to secure the container module 10 within the casing frame so as to prevent it from coming out of place and to hold it in the desired position.

The FIGS. 2 and 3 illustrate a radio wristwatch of the invention. The casing 30 of the radio wristwatch includes a substantially annular casing frame 32, a glass ring 36, which is removably mounted to the upper side of the casing frame 32 and firmly holds a watch-glass 34, and a bottom 38, which is mounted to the lower side of the casing frame 32. The bottom 38 is preferably formed from a nonconductive material and is solidly mounted to the casing frame 32.

On the lower edge of the casing frame 32 there is formed a shoulder 39 onto which the container module 10 comes to rest.

On the side of the movement carrier 12, a clock face 40 and two hands 42 are mounted to the container module 10. This encapsulated container module 10 with the clock face 40 and the hands 42 mounted thereon is inserted from the top into the casing frame 32 in only one step, with the position lugs or position recesses that have not been illustrated herein ensuring that the container module 10 be secured in place in the casing frame 32. Next, a minute ring 35 and the glass ring 36 are mounted to the casing frame 32 in a well-known manner with the casing being closed thereby. The container module is thereby dimensioned such that the glass ring 36 comes to rest against the container cover 14, thus fixing the entire container module 10 within the casing 30.

With such an arrangement of a fixed bottom 38 and a removable glass ring (lunette glass) 36, it is possible to implement the casing frame 32 to be relatively thin since the forces acting thereon are minimized. As a result of this circumstance and of the fact that the actual bottom ring can be eliminated, such a casing comprises far less metal, which in turn results in a significantly reduced shielding of the aerial.

### LIST OF NUMERALS

10 container module
12 movement carrier
14 container cover
16 aerial
18 shoulder
20 printed circuit board
22 battery
24 recess
26 detent lug
28 detent slot
30 casing
32 casing frame
34 watch-glass
35 minute ring
38 bottom
40 clock face
42 hand

I claim:

1. A radio wristwatch with a receiving unit, an aerial (16) and a clockwork that are all housed in a casing (30), said casing (30) including a substantially annular casing frame (32),
characterized by a separate container module (10) that accommodates the receiving unit, the aerial (16) and the clockwork, a glass ring (36) retaining a watch-glass (34) being removably mounted on the upper side of the casing frame (32), a bottom (38) being firmly inserted on the lower side of the casing frame (32) and the container module (10) being form-fittingly inserted from the top into the casing frame (32) and fixed in the casing by said glass ring (36).

2. The radio wristwatch as set forth in claim 1,
characterized in that the bottom (38) is directly fastened to the casing frame (32).

3. The radio wristwatch as set forth in claim 1,
characterized in that the container module (10) includes a movement carrier (12) carrying the aerial (16) and the clockwork and a container cover (10) fastened to the movement carrier (12).

4. The radio wristwatch as set forth in claim 3,
characterized in that the clockwork retained on the movement carrier (12) includes a printed circuit board (20), a wheel train and an energy storage unit.

5. The radio wristwatch as set forth in claim 4,
characterized in that the energy storage unit is configured to be a battery (22) and that a recess (24) for replacing the battery (22) is provided in the container cover (10).

6. The radio wristwatch as set forth in claim 3,
characterized in that at least one, preferably two, detent lugs (26) are formed on the movement carrier (32) and that two mating detent slots (28) are formed on the container cover (14) to correspond with said detent lugs (26).

7. The radio wristwatch as set forth in claim 3,
characterized in that a position recess or a position lug is formed on the movement carrier (12).

8. The radio wristwatch as set forth in claim 3,
characterized in that a position recess or a position lug is formed on the container cover (14).

9. The radio wristwatch as set forth in claim 1,
characterized in that a clock face (40) or an LCD-display is mounted to the container module (10).

10. The radio wristwatch as set forth in claim 1,
characterized in that an inwardly directed shoulder (39) against which the container module (10) comes to rest is formed in the casing frame (32), preferably in the lower region of the casing frame (32).

11. The radio wristwatch as set forth in claim 1,
characterized in that the container module (10) together with a clock face (40) and at least one hand (42) is inserted from the top into the casing frame (32).
